(19) United States
(12) Patent Application Publication
(10) Pub. No.: US 2005/0047990 A1
(43) Pub. Date: Mar. 3, 2005

(54) Method of stabilizing packaged active chlorine-containing solutions against light-induced degradation employing stabilized hypochlorite solutions in combination with a container

(76) Inventors: Wayne M. Rees, Racine, WI (US); Terry M. Kovara, Racine, WI (US); Susan L. Cooper, Racine, WI (US)

Correspondence Address: S.C. JOHNSON & SON, INC., 1525 HOWE STREET, RACINE, WI, 53403-2236, US

(21) Appl. No.: 10/654,327

(22) Filed: Sep. 3, 2003

(51) Int. Cl. C01B 11/04

(52) U.S. Cl. 423/473

(57) ABSTRACT

A method of reducing light-induced degradation of stabilized hypochlorite solutions when packaged in a container which is in whole or in part transparent or semi-transparent is described. The method involves incorporating at least one UV blocker in at least the transparent or semi-transparent portion of the container or incorporating a UV blocker in a wrap which overlays at least the transparent or semi-transparent portion of the container. The container or wrap is composed of plastic such as polyethylene terephthalate, polyethylene, polypropylene, polystyrene or polyvinyl chloride. The UV blocker is present in a concentration of about 0.01-2.0% by weight and serves to provide reduction in transmission of UV light in a wavelength range of from about 300-400 nm. The stabilized hypochlorite solution is a buffered aqueous combination of mono-N-chlorosulfamate and di-N-chlorosulfamate salts. The invention is also directed to the stabilized hypochlorite solution in combination with a container for the solution, the container being in whole or in part transparent or semi-transparent and having at least one UV blocker present in relation thereto.

### FIELD OF INVENTION

The invention is directed to a method of stabilizing packaged active-chlorine containing solutions against light-induced degradation, employing a combination of a stabilized hypochlorite solution with a container, wherein the packaging container is transparent or semi-transparent in whole or in part. The method and combination of the invention include providing a container having at least a portion thereof being transparent or semi-transparent and including at least one UV blocker in relation to the transparent or semi-transparent portion to reduce transmission of UV light to the stabilized hypochlorite solution.

### BACKGROUND OF THE INVENTION

Active chlorine-containing compounds are oxidizing chlorine-containing substances. This invention, in particular, is directed to materials which produce hypochlorous acid (HOCl) or hypochlorite ion (OCl⁻)in water. Common examples include sodium hypochlorite, hypochlorous acid, halogenated (N-chloro) cyanuric acids/cyanurates, halogenated (N-chloro) hydantoins, halogenated sulfamate (e.g. N-chlorosulfamates), and N-chloro derivatives of arylsulfonamides, glycouril, and melamine.

When dissolved in aqueous solutions, active chlorine-containing compounds are sensitive to light-induced degradation (photolytic decomposition). U.S. Pat. No. 2,988,471 discloses a method for stabilizing active chlorine solutions by reducing the degradation to the solutions caused by sunlight using cyanuric acid additives. Similarly, U.S. Pat. No. 4,187,293 discloses a method for stabilizing active chlorine solutions against degradation by UV light using imidodisulfonic acid, and salts thereof. These two methods were noted to be particularly useful in the photolytic stabilization of active chlorine compounds in swimming pools when exposed to sunlight.

For many types of cleaning and deodorizing applications, it is preferable to use liquid compositions since such are generally regarded as convenient and easy to use. Transparent or semi-transparent packaging is highly desirable for liquid household cleaner formulations for practical and/or aesthetic purposes. As compared to opaque containers, transparent and semi-transparent packaging can provide advantages for consumer dispensing, especially with regard to seeing the level of the product therein during dispensing and determining the extent of product use and, thus, when more product should be purchased. Consumers also prefer the aesthetics of “see-through” packaging, i.e., where the product is clearly visible. For example, a product may be colored to provide aesthetic appeal in itself and/or to suggest and complement a fragrance provided in the product.

Household and industrial cleaning products often contain active chlorine compounds for their cleaning, bleaching, biocidal, and deodorizing properties. Liquid cleaners containing active chlorine compounds which are packaged in transparent or semi-transparent containers, however, are susceptible to light-induced decomposition of the active chlorine compounds. For this reason, such cleaners are packaged in opaque containers to prevent the rapid loss of active chlorine when exposed to light from various sources such as indoor artificial lighting, sunlight through glass, unfiltered sunlight, and the like. Thus, cleaning products containing an active chlorine compound cannot take advantage of transparent or semi-transparent containers.

Accordingly, it would be advantageous to be able to provide a hypochlorite solution packaged in a container which is in whole or in part transparent or semi-transparent. Thus, more versatile container packaging would be available for hypochlorite solutions to address the needs and satisfy the aesthetic desires of the consumer.

### OBJECTS AND BRIEF DESCRIPTION OF THE INVENTION

Accordingly, it is a primary object of the invention to provide a method of protecting stabilized hypochlorite solutions against light-induced degradation when enclosed in a container which is in whole or in part transparent or semi-transparent.

It is a further primary object of the invention to provide a combination of a stabilized hypochlorite solution and container which is in whole or in part transparent or semi-transparent wherein the container protects the stabilized hypochlorite solution against light-induced degradation.

The present invention relates to active chlorine containing compositions herein referred to as “stabilized hypochlorite solutions”, and in particular to a stabilized hypochlorite solution which includes a buffered aqueous combination of mono-N-chlorosulfamate (HClNSO₃⁻) and di-N-chlorosulfamate (Cl₂NSO₃⁻) salts. The solution is buffered to a pH within the range of about 2-10, preferably a pH in a range of about 3-7. Aqueous stabilized hypochlorite solutions packaged in conventional transparent or semi-transparent containers exhibit significant photolytic degradation of the active chlorine content when exposed to typical sources of light, such as fluorescent light and sunlight through glass. The present invention is directed to a method of inhibiting the photolytic degradation of stabilized hypochlorite solutions, when packaged in containers which are in whole or in part transparent or semi-transparent. This is accomplished by providing at least one UV blocker in relation to the transparent or semi-transparent portion of the container. The UV blocker may be incorporated directly into the transparent or semi-transparent portion of the container or be incorporated in a wrap positioned around the exterior of the container, e.g. a wrap placed in contact with the exterior of the container substantially overlaying the transparent or semi-transparent portion, or incorporated in a packaging for the container, such as bubble wrap, positioned over the transparent or semi-transparent portion.

UV blockers suitable for use preferably absorb light in the wavelength range of about 300-400 nm. The UV blocker is present in a total concentration of about 0.01-2% by weight in the transparent or semi-transparent portion of a container or wrap. Examples of suitable plastic resins include polyethylene terephthalate, polyethylene, polypropylene, polyethylene terephthalate glycol, polyvinyl chloride, polystyrene, and derivatives thereof.

### DETAILED DESCRIPTION OF PREFERRED EMBODIMENTS

The invention concerns a method of providing a stabilized hypochlorite solution in a container which is in whole or in part transparent or semi-transparent, as well as the combination of the stabilized hypochlorite solution and the container. “Transparent” with reference to the container is understood to include colorless and colored (e.g. tinted) containers or portions of containers. “Semi-transparent” includes containers or portions of containers made for example from “natural” polyethylene, which has a slightly hazy appearance. “Transparent” and “semi-transparent” are used to describe container walls or wall portions, or wraps, which allow for the transmission of visible light therethrough such that liquid product is visible to an observer, within a filled or partially filled container.

For long-term storage and stability of aqueous stabilized hypochlorite solution household cleaners, the lowest energy wavelengths of UV light, i.e., from about 300-400 nm, are of practical concern from the standpoint of light-induced degradation of the active chlorine present in the cleaner. In particular, certain types of indoor lighting, such as sunlight through glass and fluorescent lighting, are of greatest concern since this type of lighting contains significant amounts of low energy UV light and are commonly encountered in retail and household environments. Long-term exposure of stabilized hypochlorite cleaning product solutions to low energy UV light will lead to undesirable degradation of these solutions.

The inclusion of at least one UV blocker to transparent or semi-transparent container material, or provision of a wrap including at least one UV blocker for overlaying the transparent or semi-transparent container, significantly reduces light-induced degradation of aqueous stabilized hypochlorite solutions. As used herein, the term “UV blocker” includes any single compound or combination of compounds which absorbs or reflects UV light, when incorporated into plastic package components, such that transmission of UV light to the container contents is reduced.

Transparent containers useful in the invention can be preferably made of polyethylene terephthalate (PET) [including polyethylene terephthalate glycol (PETG)], polystyrene (PS), or polyvinyl chloride (PVC) resins. Such containers may either be colorless or tinted (colored). Semi-transparent containers useful in the invention preferably can be made of polyethylene (PE) or polypropylene (PP) resins which provide a slightly hazy appearance to the container made therefrom. Other transparent and semi-transparent container resins can also be employed, as long as they are compatible with the stabilized hypochlorite solutions. When the UV blocker is incorporated into an outer wrap, the wrap may be of a form which contacts the container, such as a film, or can be external package component, such as bubble wrap. Each encompasses the container in application.

A variety of UV blockers are manufactured for use as plastics additives. UV blockers suitable for use in the invention are UV blocker compounds which absorb low energy UV light. Absorbance of light is preferably in the wavelength range of from about 300-400 nm. The wavelength range of the light absorbed may vary outside the above range depending on the UV blocking compound(s) utilized. Representative examples of UV blockers suitable for use include TINUVIN 234, TINUVIN 326, and TINUVIN 1577 (sold by Ciba Speciality Chemicals, Inc.) and SANDUVOR VSU (an oxalanilide derivative) and SANDUVOR 3035 (a benzophenone) (sold by Clariant Corporation). Additional examples of UV blockers, suitable as additives for plastic packaging can be found in the Handbook of Industrial Chemical Additives (VCH Publishers) and 2002 McCutcheon's, Volume 2: Functional Materials, North American Edition (The Manufacturing Confectioner Publishing Co.). Suitable families of UV blockers which may be employed in the invention include benzophenones, benzotriazoles, oxalanilides, benzylidene malonates, phenyl substituted triazines, ultra-fine titanium dioxide and zinc oxide. Other classes of UV blocking plastic additives may also be useful. In some cases, UV blockers have been formulated directly into liquid compositions. However, UV blockers generally are not chemically stable or effective when formulated into active chlorine-containing solutions. As such, incorporation of the UV blocker into the resin used to provide a container or a wrap is highly advantageous.

The UV blocker(s) can be incorporated into the transparent or semi-transparent portion of the container or wrap plastic in a concentration of from about 0.01 to 2.0% by weight, preferably about 0.05 to 0.5% by weight. The amount of the UV blocker(s) necessary for adequate photolytic protection of the stabilized hypochlorite solution may vary with variance in the wall thickness of the container or wrap. Greater amounts of UV blocker(s) will be required for containers having relatively thin walls or wraps made of thin films. Ideally, the UV blocker(s) are uniformly dispersed throughout the container plastic or wrap, or uniformly dispersed throughout the transparent or semi-transparent regions of the container or wrap. In a preferred embodiment, a complete container for a stabilized hypochlorite solution is transparent or semi-transparent and has a UV blocker dispersed throughout the container structure. When a container is transparent or semi-transparent in whole or in part but does not contain an UV blocker within the plastic used to make the container, a wrap, preferably a film or bubble wrap, can be placed encompassing the exterior wall of the container at least over the transparent or semi-transparent portions of the container. A “film wrap” is a plastic film in complete or near-complete contact with at least the transparent or semi-transparent container walls, whereas a “bubble wrap” is a plastic which encompasses at least the transparent or semi-transparent container walls yet is largely separated from the container by a void space. A container may be formed where only a portion of the container is transparent or semi-transparent, such as when a “window” is provided to view the container contents so that the product level can be readily determined. In accordance with the invention, the UV blocker can be incorporated into the material used to form the window or in a wrap for the window to prevent light-induced degradation of a stabilized hypochlorite solution contained in the container.

Any vessel designed for long-term storage of a stabilized hypochlorite solution is to be construed as a container within the invention whether such container is independent or used in combination with another article or apparatus. For example, a transparent or semi-transparent liquid reservoir chamber intended to contain a stabilized hypochlorite solution forming part of a mechanical dispensing device is considered to be a container within the meaning of the invention.

The following examples are presented to illustrate preferred embodiments and utility of the present invention.

### EXAMPLE 1

Clear plastic PET bottles were prepared with and without UV blocker additives. The bottles were injection blow molded, having a 28 mm threaded neck finish, an average panel wall thickness of 0.014 inches, and an average handle area wall thickness of 0.045 inches.

Transmittance spectra for the bottle plastic was obtained using flat panel sections cut from these containers, and scanned using a Hach DR/4000 UV/VIS spectrophotometer.

TABLE 1
% Light Transmittance Through PET Bottles +/− UV Blocker

| Wavelength | | | | |
|---|---|---|---|---|
| (nm) | PET-A | PET-B | PET-C | PET-D |
| 330 | 35.5 | 0.1 | 0.0 | 0.3 |
| 360 | 63.0 | 0.1 | 0.0 | 0.1 |
| 390 | 77.2 | 0.3 | 3.2 | 7.4 |

PET-A = Bottle resin contained no added UV blocker.
PET-B = Bottle resin contained added UV blocker of a formulation 1.
PET-C = Bottle resin contained added UV blocker of a formulation 2.
PET-D = Bottle resin contained added UV blocker of a formulation 3.

Formulations 1, 2 and 3 are all different formulations with respect to each other.

Thus, the data in Table 1 demonstrates that the inclusion of a UV blocker into the PET bottle resin greatly reduces the transmission of low energy UV light (about 300-400 nm) through the walls of the clear plastic PET bottle.

### EXAMPLE 2

### Stabilized Hypochlorite Solutions

A typical aqueous stabilized hypochlorite solution is composed of a mixture of mono-N-chlorosulfamate and di-N-chlorosulfamate, commonly as sodium or potassium salts. Solutions can also contain non-chlorinated sulfamate. Generally for good chemical stability, the solutions contain at least about 1:1 mole ratio of stabilizer (sulfamate) to hypochlorite source. U.S. Pat. Nos. 6,162,371 and 6,471,974 B1 disclose examples of stabilized hypochlorite solutions. Each of U.S. Pat. Nos. 6,162,371 and 6,471,974 B1 are incorporated herein by reference. Plastic containers formed from PET, polyethylene (PE) or polypropylene (PP) are particularly preferred for use with N-chlorosulfamate-containing solutions.

A representative stabilized hypochlorite solution was prepared according to procedures disclosed in U.S. Pat. No. 6,471,974 B1. The representative stabilized hypochlorite formulation has the following composition:

| | Weight % in |
|---|---|
| Ingredient | Formulation |
| Sodium Citrate | 0.61 |
| Sulfamic Acid | 0.42 |
| 1,3-dichloro-5,5- | 0.30 |
| dimethylhydantoin | |
| Sodium polyacrylate | 0.10 |
| Anionic surfactants | 1.50 |
| Nonionic surfactant | 0.10 |
| Fragrance | 0.04 |
| Water | To 100% |

Anionic and nonionic surfactants suitable for use are as disclosed in U.S. Pat. No. 6,471,974 B1. The freshly prepared solution had an initial active chlorine content of 0.223%, expressed as weight % NaOCl. The pH of the solution was 5.2.

### EXAMPLE 3

### Evaluation of Photolytic Degradation

The stabilized hypochlorite solution described in Example 2 was packaged in various plastic containers and placed in a high intensity fluorescent light box, where the solutions were subjected to accelerated photolytic aging at ambient temperature (ca. 28° C.). The containers were periodically removed from the light box and the solutions therein analyzed for active chlorine content. Samples for each container type were conducted in triplicate and averages calculated for each time interval. The results of the analyses are provided in Table 3.

TABLE 3
Active Chlorine Loss In Various Bottles -
% NaOCl After Aging In Light Box

| | | | | Active |
|---|---|---|---|---|
| | | | | Chlorine |
| | 2 | 4 | 6 | Loss at 6 |
| Bottle Type | Weeks | Weeks | Weeks | Weeks |
| Control = White Opaque | 0.213 | 0.205 | 0.192 | 14% |
| Polyethylene (PE) | | | | |
| Clear PET A - No UV | 0.175 | 0.112 | 0.070 | 69% |
| Blocker | | | | |
| Clear PET B - With UV | 0.208 | 0.185 | 0.169 | 24% |
| Blocker Formulation 1 | | | | |
| Clear PET C - With UV | 0.201 | 0.175 | 0.150 | 33% |
| Blocker Formulation 2 | | | | |

PET A, PET B and PET C are the same container types utilized in Example 1. UV blocker formulations 1 and 2 are also the same as utilized in Example 1.

The stabilized hypochlorite solution, packaged in a control container consisting of opaque white PE, lost 14% of the initial active chlorine content during the 6 week test period. The stabilized hypochlorite solution packaged in the clear PET container without UV blocker lost 69% of the initial active chlorine content. In comparison, samples contained in clear PET containers which include UV blocker Formulations 1 and 2 experienced only a 24% and 33% loss, respectively, of active chlorine content after 6 weeks of high intensity photolytic aging, which is substantially less than samples packaged in the clear PET bottle without UV blocker.

### EXAMPLE 4

The following examples further demonstrate the utility of incorporating a UV blocker into a clear plastic container enclosing a stabilized hypochlorite solution. The clear containers are the PET-A and PET-D bottles described in Example 1 above. The stabilized hypochlorite solution is of the composition described in Example 2. The bottled samples were evaluated for active chlorine content after 4 weeks exposure to the below described conditions. The results are provided in Table 4 below.

TABLE 4
Active Chlorine Retention - 4 Week Test

| | | | % Active Chlorine |
|---|---|---|---|
| | | | Retention Relative |
| Container | Light | % NaOCl | To Control |
| White PE | Dark | 0.215 | Control 1 |
| | | | (Dark Bottles) |
| White PE | Window | 0.201 | Control 2 |
| | | | (Window Bottles) |
| White PE | Light Box | 0.197 | Control 3 |
| | | | (Light Box Bottles) |
| PET-A | Dark | 0.215 | 100 |
| PET-A | Window | 0.065 | 31 |
| PET-A | Light Box | 0.116 | 56 |
| PET-D | Dark | 0.214 | 99 |
| PET-D | Window | 0.149 | 71 |
| PET-D | Light Box | 0.166 | 80 |

White PE = White opaque polyethylene bottles.
PET-A = Clear PET bottles without added UV Blocker.
PET-D = Clear PET bottles with UV blocker formulation 3.
Dark = containers stored in dark, 4 weeks.
Window = containers stored on interior windowsill, 4 weeks daily exposure to interior sunlight.
Light Box = 4 week exposure to continuous high intensity fluorescent lighting in test chamber.

Thus, the clear PET-A bottled samples without UV blocker retained only 56% of the NaOCl content after 4 weeks upon exposure to high intensity fluorescent light and only 31% upon daily exposure to interior sunlight, relative to the opaque PE bottle control. In comparison, the PET-D bottled samples containing UV blocker formulation 3 retained 80% and 71% of their NaOCl content, respectively.

The present invention thus advantageously provides a method of significantly reducing light-induced degradation of a stabilized hypochlorite solution packaged in a container which is transparent or semi-transparent, either in whole or in part. The combined stabilized hypochlorite solution and container provided result in a product having long term shelf-stability while allowing for visibility of the container contents. The invention allows for wide versatility in container structure for containers enclosing hypochlorite solutions.

As will be apparent to one skilled in the art, various modifications can be made within the scope of the aforesaid description. Such modifications being within the ability of one skilled in the art form a part of the present invention and are embraced by the appended claims.

1. A method of reducing light-induced degradation of stabilized hypochlorite solutions comprising
providing a stabilized hypochlorite solution, and
enclosing said stabilized hypochlorite solution in a container,
wherein at least a portion of said container is transparent or semi-transparent and said at least a portion of said container includes at least one UV blocker therein so as to provide a reduction in transmission of UV light through said at least a portion of said container to said stabilized hypochlorite solution.

2. A method of reducing light-induced degradation of stabilized hypochlorite solutions comprising
providing a stabilized hypochlorite solution, and
enclosing said stabilized hypochlorite solution in a container,
wherein at least a portion of said container is transparent or semi-transparent and a transparent or semi-transparent wrap overlays at least said at least a portion of said container, and said wrap includes at least one UV blocker therein so as to provide a reduction in transmission of UV light through said wrap to said stabilized hypochlorite solution.

3. A method according to claim 2, wherein said wrap is a film wrap material.

4. A method according to claim 2, wherein said wrap is bubble wrap material.

5. A method according to claim 1, wherein said at least one UV blocker is present in a concentration of about 0.01-2.0% by weight of said at least a portion of said container.

6. A method according to claim 2, wherein said at least one UV blocker is present in a concentration of about 0.01-2.0% by weight of said wrap.

7. A method according to claim 1, wherein said at least one UV blocker is present in a concentration of about 0.05-0.5% by weight of said at least a portion of said container.

8. A method according to claim 2, wherein said at least one UV blocker is present in a concentration of about 0.05-0.5% by weight of said wrap.

9. A method according to claim 1, wherein said UV light is in a wavelength range of about 300-400 nm.

10. A method according to claim 2, wherein said UV light is in a wavelength range of about 300-400 nm.

11. A method according to claim 1, wherein said at least one UV blocker is a benzophenone, benzotriazole, oxalanalide, benzylidene malonate, phenyl substituted triazine, titanium dioxide and/or zinc oxide.

12. A method according to claim 2, wherein said at least one UV blocker is a benzophenone, benzotriazole, oxalanalide, benzylidene malonate, phenyl substituted triazine, titanium dioxide and/or zinc oxide.

13. A method according to claim 1, wherein said stabilized hypochlorite solution comprises a buffered aqueous mixture of mono-N-chlorosulfamate and di-N-chlorosulfamate salts.

14. A method according to claim 2, wherein said stabilized hypochlorite solution comprises a buffered aqueous mixture of mono-N-chlorosulfamate and di-N-chlorosulfamate salts.

15. A method according to claim 1, wherein said container is a plastic container.

16. A method according to claim 2, wherein said wrap is plastic.

17. A method according to claim 15, wherein said plastic container is made from a polyethylene terephthalate resin, a polyethylene resin, a polypropylene resin, a polyvinyl chloride resin, a polystyrene resin, or derivative thereof.

18. A method according to claim 16, wherein said plastic is a polyethylene terephthalate resin, a polyethylene resin, a polypropylene resin, a polyvinyl chloride resin, a polystyrene resin, or a derivative thereof.

19. A method of reducing light-induced degradation of stabilized hypochlorite solutions comprising
providing a stabilized hypochlorite solution comprising a buffered aqueous solution including a mixture of mono-N-chlorosulfamate and di-N-chlorosulfamate salts, and
enclosing said stabilized hypochlorite solution in a plastic container,
wherein at least a portion of said container is transparent or semi-transparent and said at least a portion of said container includes at least one UV blocker in a concentration of about 0.01-2.0% by weight therein so as to provide a reduction in transmission of UV light in a range of about 300 to 400 nm through said at least a portion of said container to said stabilized hypochlorite solution.

20. A method of reducing light-induced degradation of stabilized hypochlorite solutions comprising
providing a stabilized hypochlorite solution comprising a buffered aqueous solution including a mixture of mono-N-chlorosulfamate and di-N-chlorosulfamate salts, and
enclosing said stabilized hypochlorite solution in a plastic container,
wherein at least a portion of said container is transparent or semi-transparent and a transparent or semi-transparent wrap overlays said at least a portion of said container, and said wrap includes at least one UV blocker in a concentration of about 0.01-2.0% by weight therein so as to provide a reduction in transmission of UV light in a range of about 300 to 400 nm through said wrap to said stabilized hypochlorite solution.

21. A method according to claim 20, wherein said wrap is a film wrap material.

22. A method according to claim 20, wherein said wrap is bubble wrap material.

23. A method according to claim 19, wherein said at least one UV blocker is present in a concentration of about 0.05-0.5% by weight of said at least a portion of said container.

24. A method according to claim 20, wherein said at least one UV blocker is present in a concentration of about 0.05-0.5% by weight of said wrap.

25. A method according to claim 19, wherein said at least one UV blocker is a benzophenone, benzotriazole, oxalanalide, benzylidene malonate, phenyl substituted triazine, titanium dioxide and/or zinc oxide.

26. A method according to claim 20, wherein said at least one UV blocker is a benzophenone, benzotriazole, oxalanalide, benzylidene malonate, phenyl substituted triazine, titanium dioxide and/or zinc oxide.

27. A method according to claim 19, wherein said plastic container is made from a polyethylene terephthalate resin, a polyethylene resin, a polypropylene resin, a polyvinyl chloride resin, a polystyrene resin, or a derivative thereof.

28. A method according to claim 20, wherein said wrap is made from a polyethylene terephthalate resin, a polyethylene resin, a polypropylene resin, a polyvinyl chloride resin, a polystyrene resin, or a derivative thereof.

29. A stabilized hypochlorite solution in combination with a container comprising
a buffered aqueous solution including a mixture of mono-N-chlorosulfamate and di-N-chlorosulfamate salts, and
a container wherein at least a portion of the container is transparent or semi-transparent, and said at least a portion of the container includes at least one UV blocker therein so as to provide a reduction in transmission of UV light through said at least a portion of the container to said buffered aqueous solution,
wherein said buffered aqueous solution is enclosed within said container.

30. A stabilized hypochlorite solution in combination with a container comprising
a buffered aqueous solution including a mixture of mono-N-chlorosulfamate and di-N-chlorosulfamate salts, and
a container wherein at least a portion of the container is transparent or semi-transparent and a transparent or semi-transparent wrap overlays at least said at least a portion of the container, and said wrap includes at least one UV blocker therein so as to provide a reduction in transmission of UV light through said wrap to said buffered aqueous solution,
wherein said buffered aqueous solution is enclosed within said container.

31. A stabilized hypochlorite solution in combination with a container according to claim 30, wherein said wrap is a film wrap material.

32. A stabilized hypochlorite solution in combination with a container according to claim 30, wherein said wrap is a bubble wrap material.

33. A stabilized hypochlorite solution in combination with a container according to claim 29, wherein said at least one UV blocker is present in a concentration of about 0.01-2.0% by weight of said at least a portion of said container.

34. A stabilized hypochlorite solution in combination with a container according to claim 30, wherein said at least one UV blocker is present in a concentration of about 0.01-2.0% by weight of said wrap.

35. A stabilized hypochlorite solution in combination with a container according to claim 29, wherein said at least one UV blocker is present in a concentration of about 0.05-0.5% by weight of said at least a portion of said container.

36. A stabilized hypochlorite solution in combination with a container according to claim 30, wherein said at least one UV blocker is present in a concentration of about 0.05-0.50% by weight of said wrap.

37. A stabilized hypochlorite solution in combination with a container according to claim 29, wherein said UV light is in a wavelength range of about 300-400 nm.

38. A stabilized hypochlorite solution in combination with a container according to claim 30, wherein said UV light is in a wavelength range of about 300-400 nm.

39. A stabilized hypochlorite solution in combination with a container according to claim 29, wherein said at least one UV blocker is a benzophenone, benzotriazole, oxalanalide, benzylidene malonate, phenyl substituted triazine, titanium dioxide and/or zinc oxide.

40. A stabilized hypochlorite solution in combination with a container according to claim 30, wherein said at least one UV blocker is a benzophenone, benzotriazole, oxalanalide, benzylidene malonate, phenyl substituted triazine, titanium dioxide and/or zinc oxide.

41. A stabilized hypochlorite solution in combination with a container according to claim 29, wherein said container is a plastic container.

42. A stabilized hypochlorite solution in combination with a container according to claim 41, wherein said plastic container is made from a polyethylene terephthalate resin, a polyethylene resin, a polypropylene resin, a polyvinyl chloride resin, a polystyrene resin, or a derivative thereof.

43. A stabilized hypochlorite solution in combination with a container according to claim 30, wherein said wrap is plastic.

44. A stabilized hypochlorite solution in combination with a container according to claim 43, wherein said plastic is a polyethylene terephthalate resin, a polyethylene resin, a polypropylene resin, a polyvinyl chloride resin, a polystyrene resin, or a derivative thereof.
